(19) United States
(12) Patent Application Publication
(10) Pub. No.: US 2023/0023710 A1
(43) Pub. Date: Jan. 26, 2023

(54) SYNCHRONOUS RELUCTANCE MACHINE HAVING A VARIABLE AIR GAP

(71) Applicant: IFP Energies nouvelles, RUEIL-MALMAISON (FR)

(72) Inventors: Abdenour ABDELLI, RUEIL-MALMAISON CEDEX (FR); Baptiste CHAREYRON, RUEIL-MALMAISON CEDEX (FR); Benjamin GAUSSENS, RUEIL-MALMAISON CEDEX (FR); Thomas VALIN, RUEIL-MALMAISON CEDEX (FR)

(21) Appl. No.: 17/783,722

(22) PCT Filed: Dec. 3, 2020
(86) PCT No.: PCT/EP2020/084526

§ 371 Date: Jun. 9, 2022

(30) Foreign Application Priority Data
Dec. 17, 2019 (FR) FR1914639

(51) Int. Cl. H02K 21/02

(52) U.S. Cl. CPC H02K 21/025; H02K 2201/03; H02K 2213/03

(57) ABSTRACT

The present invention is a variable air gap in a rotary electric machine, notably a permanent magnet-assisted synchronous reluctance electric machine.

Reference is made to PCT/EP2020/084526 filed Dec. 3, 2020, designating the United States, and French Application No. 19/14.639 filed Dec. 17, 2019, which are incorporated herein by reference in their entirety.

### BACKGROUND OF THE INVENTION

### Field of the Invention

The present invention relates to a rotary electric machine, notably a (permanent magnet-assisted) synchronous reluctance electric machine, and more particularly to a variable air gap of such a machine, operating with a bus delivering a preferably direct current voltage and providing high rotational speed.

### Description of the Prior Art

A rotary electric machine comprises a stator and a rotor coaxially arranged in one another.

The rotor of a permanent magnet-assisted synchronous reluctance electric machine usually has a rotor body with a bundle of laminations arranged on a rotor shaft. These laminations include housings for permanent magnets, and perforations for creating flux barriers allowing the magnetic flux of the magnets to be radially directed towards the stator and for promoting the generation of a reluctance torque.

This rotor is generally housed within a stator that carries electric windings that generate a magnetic field enabling the rotor to be driven in rotation.

As is better described in patent application WO-2016/188,764, the rotor comprises axial recesses running throughout the laminations.

A first series of axial recesses, radially arranged one above the other and at a distance from one another, forms housings for magnetic flux generators which are permanent magnets that are rectangular bars.

However, it is observed that the counter-electromotive force harmonics and the torque ripple are significant in this type of permanent magnet-assisted synchronous reluctance machine.

This may generate jolts and vibrations at the rotor, thus causing discomfort in using this machine.

Document CN-206,775,356U describes the sinusoidal magnetic field in the air gap, which may reduce torque ripple and electromagnetic noise. Furthermore, document CN-208,174,384U describes a recess at the surfaces of a rotor, which allows the engine torque ripple to be reduced. However, these electric machines are not optimized for a wide rotational speed range.

In general, it is observed that electric machines are optimized with a minimum air gap favoring torque or with a larger air gap favoring high-speed efficiency.

### SUMMARY OF THE INVENTION

The present invention is directed to overcoming the aforementioned drawbacks, and notably to change the air gap shape in search of both maximum torque performances at low speed for a small air-gap machine and power performance at high rotational speed of a large air-gap machine.

The present invention relates to an electric machine comprising a rotor and a stator, the rotor comprising:

p pairs of magnetic poles having each a magnetic pole axis;
an air gap defining a space between the rotor and the stator, the air gap having a non-constant radial thickness; and
characterized in that the air gap has a thickness e₀(θₘ) defined by the following formula:

$${e}_{0} ( {θ}_{m} ) = {e}_{0 , moyen} + \frac{Δ e}{2} cos ( p * {θ}_{m} * h + Δ θ )$$

where:
θₘ is the mechanical position of the air gap;
e_{0,moyen} is the average thickness of the air gap;
Δe is the maximum variation of the air gap;
p is the number of pole pairs;
h is the predetermined harmonic rank; and
Δθ is the initial radial phase difference between the axis of a magnetic pole and the point of the maximum amplitude of the sinusoidal function.

According to one embodiment, each magnetic pole has at least three magnets positioned in axial recesses.

According to one embodiment, each magnetic pole comprises three asymmetric flux barriers, which are an external flux barrier, a central flux barrier and an internal flux barrier. Each flux barrier comprises two inclined recesses positioned on either side of each axial recess. The two inclined recesses form an opening angle that corresponds to the angle between two lines passing each through the center of the rotor and through a midpoint positioned at an outer face of the respective recesses of each flux barrier and the flux barriers substantially have a flat-bottomed V shape.

According to one embodiment, the initial phase difference is directly deduced from the opening angles of the flux barriers.

According to one embodiment, the number p of magnetic pole pairs ranges between 2 and 9, preferably between 3 and 6, and most preferably 4.

According to one embodiment, the rotor has a surface of contact with the air gap, substantially cylindrical, of variable radius, and the stator has a surface of contact with the air gap, substantially cylindrical, of constant radius.

According to one embodiment, the air gap has a thickness ranging between 0.4 mm and 1 mm, and the average thickness of the air gap is preferably 0.6 mm.

According to one embodiment, the predetermined harmonic rank is an even integer.

According to one embodiment, the predetermined harmonic rank is 2 or 14, or a combination of these harmonics.

According to one embodiment, the electric machine is of synchronous reluctance electric machine type, having preferably 3 magnets in each magnetic pole.

### BRIEF DESCRIPTION OF THE FIGURES

Other features and advantages of the invention will be clear from reading the description hereafter of embodiments, given by way of non limitative example, with reference to the accompanying figures wherein:

FIG. 1 illustrates an electric machine according to the prior art;

FIG. 2 illustrates an electric machine according to the prior art;

FIG. 3 illustrates the variable air gap according to one embodiment of the invention;

FIG. 4 illustrates an example of the air gap variation as a function of the mechanical position;

FIG. 5 illustrates an example of the air gap variation as a function of the electrical position;

FIG. 6 illustrates the average torque variation as a function of rank h of the harmonic and of phase difference Δθ;

FIG. 7 illustrates the average torque ripple as a function of rank h of the harmonic and of phase difference Δθ;

FIG. 8 illustrates the maximum power variation as a function of rank h of the harmonic and of phase difference Δθ;

FIG. 9 illustrates the maximum power variation at maximum rotational speed, here 14,000 rpm, as a function of rank h of the harmonic and of phase difference Δθ; and

FIG. 10 illustrates the rotor loss variation at 70 kW at maximum rotational speed, here 14,000 rpm, as a function of rank h of the harmonic and of phase difference Δθ.

### DETAILED DESCRIPTION OF THE INVENTION

The present invention relates notably to an electric machine of a permanent magnet-assisted synchronous reluctance type. A permanent magnet-assisted synchronous reluctance electric machine is described in the rest of the description, however the invention concerns all types of permanent magnet-assisted electric machines with an inner rotor.

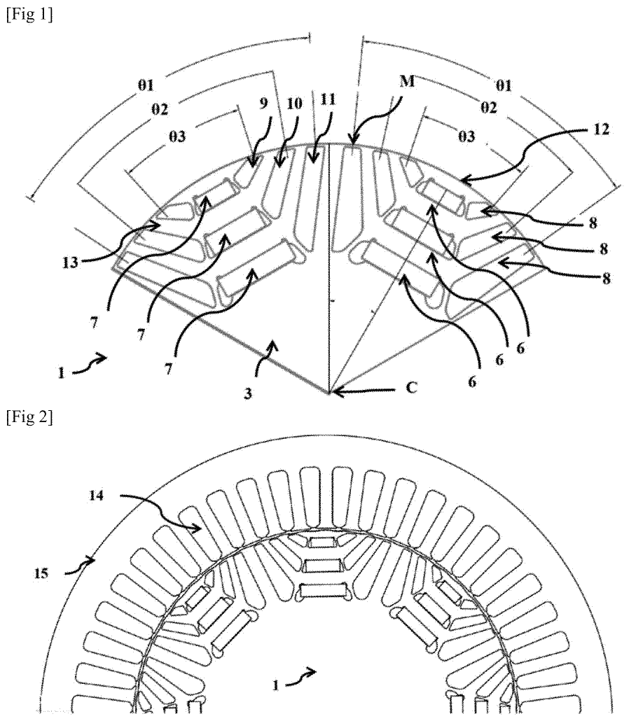

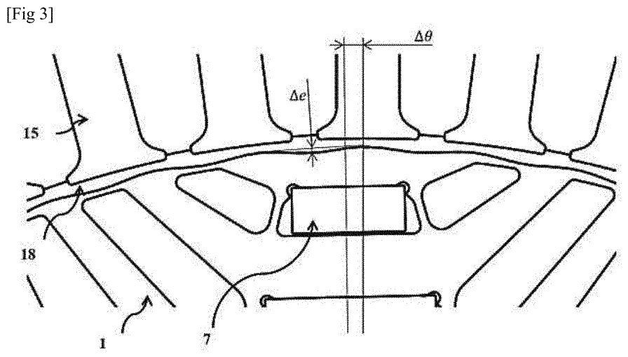

As it is generally known in the prior art, such an electric machine is shown by way of non-limitative example in FIGS. 1 and 2. The electric machine has a rotor 1 comprising, in a manner known per se, a shaft (not shown), preferably magnetic, on which a bundle of laminations 3 is arranged. These laminations 3 are advantageously ferromagnetic, flat, identical, rolled and of circular shape and are assembled to one another by any known means. Laminations 3 can have a central bore (not shown) traversed by the rotor shaft, and axial recesses 6, 8 running throughout laminations 3.

A first series of axial recesses 6 which is radially arranged above one another and at a distance from one another form housings for magnetic flux generators, which here are permanent magnets 7, preferably in the form of bars. Axial recesses 6 can substantially form trapezoids. However, axial recesses 6 can take other shapes, notably rectangular shapes, square shapes, etc.

A second series of recesses are perforations 8 of inclined direction with respect to the radial direction, starting from axial recesses 6 and ending in the vicinity 12 of the edge of laminations 3, that is at an air gap of the electric machine.

Inclined perforations 8 are arranged symmetrically with respect to recesses 6 of magnets 7 to form each time a substantially flat-bottomed V-shaped geometric figure, with the flat bottom formed by housing 6 of magnets 7 and with the inclined arms of this V shape formed by inclined perforations 8. Inclined perforations 8 form flux barriers. The magnetic flux from magnets 7 can then only transit through the solid parts of laminations 3 between the recesses. These solid parts are a ferromagnetic material.

Rotor 3 illustrated in FIG. 1 comprises p pairs of magnetic poles (or 2×p magnetic poles), a magnetic pole having three recesses 6 for the magnets on the same radial direction, and the associated flux barriers (9, 10, 11).

A pole pitch P is defined from the number p of pole pairs. Expressed in degrees, the pole pitch can be determined with a formula as follows:

$$P = \frac{360}{2 \times p}$$

For the example illustrated in FIG. 1, rotor 1 comprises eight magnetic poles (p=4): therefore the pole pitch P is 45°. Each magnetic pole has three permanent magnets 7 positioned in the three axial recesses 6 provided for housing permanent magnets 7. Rotor 1 also has three flux barriers, an external flux barrier 9 (associated with external recess 6, that is the closest to the periphery of rotor 1), a central flux barrier 10 (associated with central recess 6) and an internal flux barrier 11 (associated with internal recess 6, i.e. the closest to the center of rotor 1).

As illustrated in FIG. 2, the electric machine further comprises a stator 15. Stator 15 comprises a circular inner space for rotor 1. Stator 15 also comprises slots 14 in which magnetic flux generators (not shown) are inserted which are notably electric coils.

As can be seen in FIGS. 1 and 2, each flux barrier (9, 10, 11) comprises two inclined perforations that are arranged symmetrically with respect to the housings of magnets 7 for each magnetic pole. A substantially flat-bottomed V-shaped geometric figure is thus formed each time, the flat bottom being formed by housing 7 and the inclined arms of this V shape being formed by the inclined perforations. An opening angle (θ1, θ2, θ3) qualifying the opening of the V shape corresponds to each flux barrier (9, 10, 11) of each magnetic pole. These opening angles correspond to the angle between two lines passing each through the center C of rotor 1 and through a midpoint M positioned at an outer face 12 of perforations 8 of inclined radial direction of each flux barrier. This outer face 12 is on the periphery of rotor 1, at a mechanical air gap of the electric machine, as detailed in the rest of the description.

The invention is characterized by a variable air gap which is non-constant depending on the mechanical position (the mechanical position being the angular position at the air gap), as illustrated in FIG. 3. FIG. 3 schematically illustrates, by way of non-limitative example, the constituent elements of the electric machine around air gap 18. The figure shows an electric machine comprising a rotor 1 and a stator 15, rotor 1 having p pairs of magnetic poles each comprising a magnetic pole axis and an air gap 18 defining a space between rotor 1 and stator 15, the air gap 18 having a non-constant radial thickness. The specific feature of the invention defines the thickness e₀(θₘ) of air gap 18 with the following formula:

$${e}_{0} ( {θ}_{m} ) = {e}_{0 , moyen} + \frac{Δ e}{2} cos ( p * {θ}_{m} * h + Δ θ )$$

where:
θₘ is the mechanical position of the air gap 18;
e_{0,moyen} is the average thickness of the air gap 18;
Δe is the maximum variation of the air gap 18;
p is the number of pole pairs;
h is the predetermined harmonic rank; and
Δθ is the initial radial phase difference between the axis of a magnetic pole and the point of the maximum amplitude of the sinusoidal function.

The mechanical position θₘ of air gap 18 is the angular position along the path of air gap 18. Mechanical position θₘ is measured in degrees and it can range between 0° and 360°.

The dimension of air gap 18 is the difference between the inner radius of stator 15 and the outer radius of rotor 1.

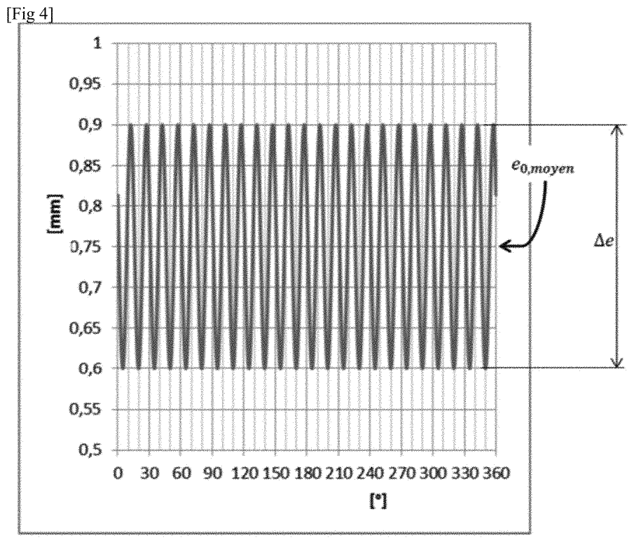

The average thickness e_{0,moyen} of air gap 18 is a design and construction parameter of the electric machine. Average thickness e_{0,moyen} of air gap 18 is measured in mm and it is determined as the average integrated in all the mechanical positions θₘ between 0° and 360°, between the point of minimum thickness of air gap 18, at a mechanical position θₘ where stator 15 and rotor 1 are closest to one another, and the point of maximum thickness, at another mechanical position θₘ where stator 15 and rotor 1 are farthest from one another. Average thickness e_{0,moyen} is shown in FIG. 4.

The maximum variation Δe of air gap 18 is measured in mm and it is determined as the difference between the point of minimum thickness of air gap 18, at a mechanical position θₘ where stator 15 and rotor 1 are closest to one another, and the point of maximum thickness, at another mechanical position θₘ where stator 15 and rotor 1 are farthest from one another.

Maximum variation Δe of air gap 18 is shown in FIG. 3. Maximum variation Δe of air gap 18 can also be seen in FIG. 4 by observing the peaks at 0.9 mm in this variant embodiment.

The initial radial phase difference Δθ is measured in degrees and it is determined as the angle between the axis of a magnetic pole (passing through the centre of rotor 1) and the radius of rotor 1 passing through the closest maximum variation point Δe. Initial radial phase difference Δθ is shown in FIG. 3.

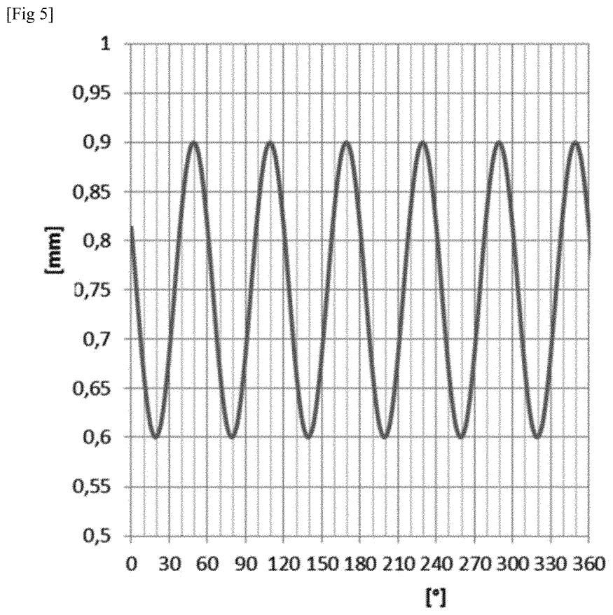

FIGS. 4 and 5 show an example of the variation of air gap 18 as a function of the mechanical position and of the electrical position respectively (θₑ=p*θₘ). For example, the shape of the air gap according to the mechanical and electrical position can be seen for a machine with 4 pole pairs, considering harmonic 6 and a 65° phase difference.

According to one embodiment of the invention, each magnetic pole of the electric machine can be at least three magnets 7 positioned in axial recesses 6. This embodiment is illustrated in FIGS. 1, 2, and partly in FIG. 3. FIG. 1 shows the three magnets 7 positioned, by way of example, in axial recesses 6 substantially forming trapezoids and having at least two parallel faces, these faces being substantially located on tangents centered on the center of rotor 1. FIG. 3 shows an axial recess 6 with substantially radial faces, along the sides of the trapezoids. Each substantially radial face has a contact and centering point for magnet 7 and, on each side of this contact point, two curved sections. These two curved sections preferably have the shape of a circular arc or, more advantageously, the shape of a water drop, and one of the two curved sections is preferably shorter than the other.

According to one embodiment of the invention, each magnetic pole of the electric machine can comprise three asymmetric flux barriers making up each magnetic pole, which are an external flux barrier 9, a central flux barrier 10 and an internal flux barrier 11. As illustrated in FIG. 1, each flux barrier 9, 10, 11 comprises two inclined recesses 8 positioned on either side of each axial recess 6. The two inclined recesses 8 form an opening angle (θ1, θ2, θ3) that corresponds to the angle between two lines passing each through center C (shown in FIG. 1) of rotor 1 and through a midpoint M (shown in FIG. 1) positioned at an outer face 12 of the respective recesses 8 of each flux barrier 9, 10, 11. The flux barriers substantially have a flat-bottomed V shape. The flux barriers perform an important role in guiding the magnetic fluxes.

According to one embodiment of the invention, initial phase difference Δθ can be directly deduced from the opening angles (θ1, θ2, θ3) of flux barriers 9, 10, 11. Indeed, initial phase difference Δθ as illustrated in FIG. 3 is a parameter that directly depends on the electric machine design choices and, first of all, on the flux barrier geometry.

According to one embodiment of the invention, the number p of magnetic pole pairs can range between 2 and 9, preferably between 3 and 6, and it is preferably 4. FIGS. 1, 2 and 3 show an electric machine with 4 magnetic poles. However, the invention can apply to any desired number of pole pairs.

According to one embodiment of the invention, rotor 1 can have a surface of contact with the air gap 18 (i.e. a surface delimiting the air gap on the rotor side), substantially cylindrical, of variable radius. Here, the air gap variation is illustrated in FIG. 4. According to this embodiment, the stator 15 has a surface of contact with the air gap 18, substantially cylindrical, of constant radius. In other words, the variation in the air gap thickness can be achieved by means of a rotor whose outer radius is not constant.

According to one embodiment of the invention, air gap 18 can have a thickness ranging between 0.4 mm and 1 mm, and the average thickness of the air gap 18 is preferably 0.7 mm. When implementing the invention, the person skilled in the art adapts the air gap thickness based on various parameters such as the overall dimensions of the constituent elements of the machine, the manufacturing precision required in the field of application and the expected performances.

In order to determine the selection of the predetermined harmonic rank h allowing the beneficial effects of the formula of the invention to be maximized, it is proposed to study by numerical simulation the most important operating parameters of the electric machine according to the variation of harmonic rank h and of phase difference Δθ, i.e.:

the average torque;
the torque ripple;
the maximum power;
the maximum power at maximum speed; and
the rotor losses.

These non-limitative examples are carried out for a permanent magnet-assisted synchronous reluctance electric machine with 4 pole pairs and 3 magnets per pole.

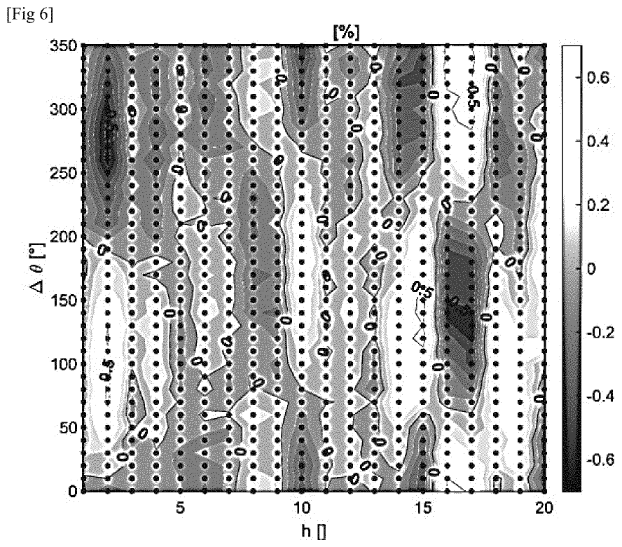

FIG. 6 illustrates the average torque variation as a function of harmonic rank h and of phase difference Δθ. According to the right-hand legend, the grey intensity level corresponds to a torque variation as a function of rank h of the harmonic and of phase difference Δθ. It is noted that the torque variation is very low, with a variation of +/−0.7%, in relation to the maximum average torque. However, it is also noted that some harmonic ranks generate a higher variation than others. For example, harmonic ranks 2, 10, 14, 15, 16 and 17 appear to have a more significant influence than the other harmonics on the average torque (see the lighter areas in the figure).

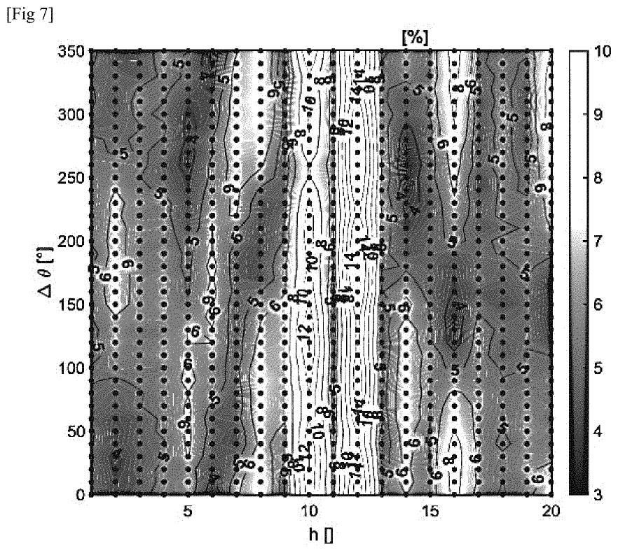

FIG. 7 illustrates the average torque ripple as a function of harmonic rank h and of phase difference Δθ. According to the right-hand legend, the grey intensity level corresponds to an average torque ripple depending on rank h of the harmonic and on phase difference Δθ. It is noted that some harmonic ranks have a highly negative impact on the electric machine performances (see the lighter areas). It is thus noted that some harmonic ranks appear to generate much ripple in the harmonic rank range between 9 and 12. The creation of new torque harmonics in this range is detrimental to the proper operation of the electric machine because what is sought is, on the contrary, a decrease in the vibrations generated by the torque ripple. As in the previous case, some harmonic and phase difference ranks seem to be more favorable to the torque ripple decrease.

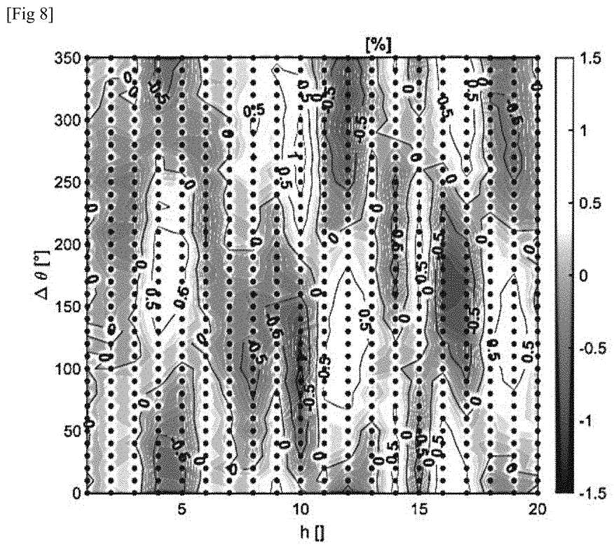

FIG. 8 illustrates the maximum power variation as a function of harmonic rank h and of phase difference Δθ. According to the right-hand legend, the grey intensity level corresponds to a maximum power depending on rank h of the harmonic and on phase difference Δθ. It is noted that the power variation is low, with a variation of +/−1.5%, in relation to the average. It is noted that the ranks of the harmonics affecting the maximum power are substantially identical to those of the average torque, such as 10 and 14 for example (see the lighter areas), but some appear, such as 4 and 5 here, while others disappear, 2 here. However, the variations are particularly low.

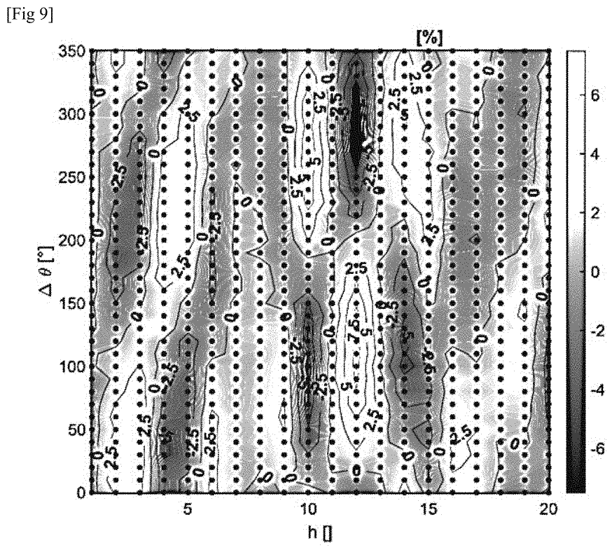

FIG. 9 illustrates the maximum power variation at maximum rotational speed, here 14,000 rpm, as a function of rank h of the harmonic and of phase difference Δθ. According to the right-hand legend, the grey intensity level corresponds to a maximum power variation as a function of rank h of the harmonic and of phase difference Δθ. It is noted that some harmonic ranks have a highly positive impact on the electric machine performances (see the lighter areas). It appears that it is potentially possible to save more than 7% in relation to the average power depending on the harmonic ranks considered, that is ranks 4, 10, 12 and 14.

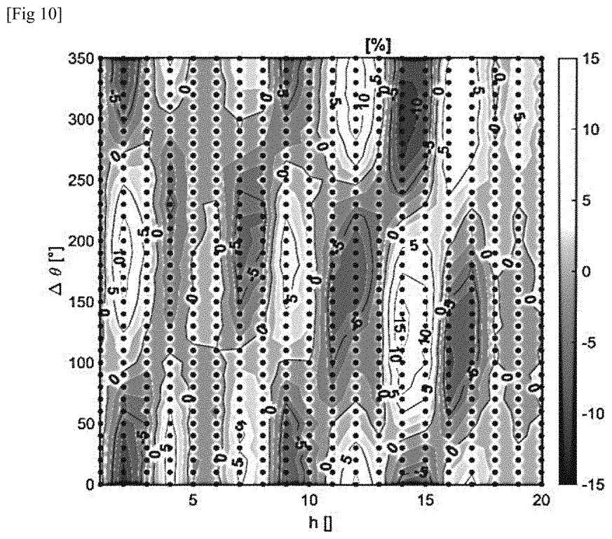

FIG. 10 illustrates the rotor loss variation at 70 kW at maximum rotational speed, here 14,000 rpm, as a function of rank h of the harmonic and of phase difference Δθ. According to the right-hand legend, the grey intensity level corresponds to a rotor loss variation as a function of rank h of the harmonic and of phase difference Δθ. It is noted that some harmonic ranks have a highly positive impact on the rotor losses, which can be decreased by 15% in relation to the average value (see the lighter areas). More particularly, harmonic ranks 2, 12 and 14 appear to be very interesting for rotor loss reduction.

The results of the above studies are given in Table 1 below (sign ø corresponds to a substantially zero impact, sign + corresponds to a positive impact, sign ++ corresponds to a highly positive impact, sign − corresponds to a negative impact, sign −− corresponds to a highly negative impact):

TABLE 1

| | Harmonic rank | | | | | | | | | | | | | | | | | | | |
|---|---|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 | 18 | 19 | 20 |
| Max | ∘ | ++ | ∘ | + | ∘ | ∘ | ∘ | ∘ | ∘ | + | ∘ | ∘ | ∘ | + | ++ | ++ | ++ | + | ∘ | ∘ |
| torque | | | | | | | | | | | | | | | | | | | | |
| Ripple | ∘ | ++ | ∘ | ∘ | + | + | ∘ | + | ∘ | −− | ∘ | −−− | ∘ | ++ | ∘ | + | ∘ | ∘ | ∘ | ∘ |
| Max | ∘ | ∘ | ∘ | + | + | ∘ | ∘ | + | ∘ | ++ | ∘ | ++ | ∘ | ++ | ++ | ++ | ++ | ∘ | ++ | ∘ |
| power | | | | | | | | | | | | | | | | | | | | |
| Power | ∘ | ++ | ++ | + | + | + | ∘ | ∘ | ∘ | ++ | ∘ | +++ | ∘ | ++ | ++ | ∘ | ∘ | ∘ | ∘ | ∘ |
| @Max | | | | | | | | | | | | | | | | | | | | |
| speed | | | | | | | | | | | | | | | | | | | | |
| Rotor | ∘ | ++ | ∘ | + | ∘ | ∘ | + | ∘ | + | ∘ | ∘ | + | ∘ | +++ | ++ | + | + | ∘ | + | ∘ |
| losses | | | | | | | | | | | | | | | | | | | | |

The advantage of the sinusoidal variable-thickness air gap allowing to tend both towards maximum torque performances at low speed, characteristic of a small air gap machine, and towards maximum efficiency and power performances at high rotational speed, characteristic of a large air gap machine, is quantified.

It is highlighted that harmonics 2 and 14 are the most interesting for the electric machine being studied.

According to one embodiment of the invention, the predetermined harmonic rank thus is an even integer. Preferably, the predetermined harmonic rank is 2 or 14. Alternatively, a combination of these harmonics can also be selected.

The results given here are shown for a machine having 4 pole pairs, but the generic formulation of the air gap shape and the study by harmonic rank allow this result to be generalized whatever the number of pole pairs.

According to one embodiment of the invention, the electric machine is a synchronous reluctance type electric machine, with four pole pairs, comprising preferably 3 magnets in each magnetic pole. Preferably, for this electric machine design, the harmonics taken into account in the formula defined for the air gap thickness are harmonics 2 and/or 14.

1-10. (canceled)

11. An electric machine comprising a rotor and a stator, the rotor comprising:
p pairs of magnetic poles each having a magnetic pole axis;
an air gap defining a space between rotor and stator, the air gap having a non-constant radial thickness; and wherein:
the air gap has a thickness e₀(θₘ) defined by the following formula:
$${e}_{0} ( {θ}_{m} ) = {e}_{0 , moyen} + \frac{Δ e}{2} cos ( p * {θ}_{m} * h + Δ θ )$$
where:
θₘ is a mechanical position of the air gap;
e_{0,moyen} is an average thickness of the air gap;
Δe is a maximum variation of the air gap;
p is a number of pole pairs;
h is a predetermined harmonic rank; and
Δθ is an initial radial phase difference between the magnetic pole axis and a point of maximum amplitude of a sinusoidal function.

12. An electric machine as claimed in claim 11, wherein each magnetic pole has at least three magnets positioned in axial recesses.

13. An electric machine as claimed in claim 12, comprising three asymmetric flux barriers forming each magnetic pole, which are an external flux barrier, a central flux barrier and an internal flux barrier, each flux barrier comprising two inclined recesses positioned on either side of each axial recess, the two inclined recesses forming an opening angle corresponding to an angle between two lines each passing through a center of the rotor and through a midpoint positioned at an outer face of the respective recesses of each flux barrier and the flux barriers each have a substantially flat-bottomed V shape.

14. An electric machine as claimed in claim 13, wherein the initial phase difference Δθ is directly deduced from opening angles of the flux barriers.

15. An electric machine as claimed in claim 11, wherein a number of magnetic pole pairs ranges between 2 and 9.

16. An electric machine in accordance with claim 15, wherein a number of poles is 4.

17. An electric machine as claimed in claim 11, wherein the rotor has a surface of contact with the air gap, which is cylindrical, of variable radius, and the stator has a cylindrical surface of contact with the air gap, which is a constant radius.

18. An electric machine as claimed in claim 11, wherein the air gap has a thickness ranging between 0.4 mm and 1 mm.

19. An electric machine in accordance with claim 18, wherein the thickness is 0.7 mm.

20. An electric machine as claimed in claim 11, wherein the predetermined harmonic rank is an even integer.

21. An electric machine as claimed in claim 11, wherein the predetermined harmonic rank is 2 or 14, or a combination of these harmonics.

22. An electric machine as claimed in claim 11, wherein the electric machine is a synchronous reluctance electric machine, having 3 magnets in each magnetic pole.
